(19) United States
(12) Patent Application Publication
(10) Pub. No.: US 2014/0218377 A1
(43) Pub. Date: Aug. 7, 2014

(54) GRAPHICS PROCESSING UNIT EXPANSION CARD AND METHOD FOR EXPANDING AND REGISTERING GRAPHICS PROCESSING UNITS

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 13/961,915

(22) Filed: Aug. 8, 2013

(30) Foreign Application Priority Data
Feb. 4, 2013 (TW) 202104178

(51) Int. Cl. G06T 1/20

(52) U.S. Cl. CPC G06T 1/20
USPC 345/504

(57) ABSTRACT

A number (n−1) of graphics processing units (GPUs) are serially connected in a sever. When an nth GPU is connected to an (n−1)th GPU of the server, a first control unit of the nth GPU is activated to send a predetermined signal to a master GPU which is connected to a motherboard of the server, to request a slave address for the nth GPU. A second control unit of the master GPU is activated to assign the slave address and send the slave address to the nth GPU, wherein the second control unit of the master GPU detects how many GPUs are connected with each other serially in the server, determines a percentage of operation loads of each of the GPUs to balance the operation loads of the GPUs, and assigns the operation loads between all the GPUs.

### BACKGROUND

1. Technical Field

Embodiments of the present disclosure relate to graphics processing units (GPUs), and more particularly to a GPU expansion card and a method for expanding the number of GPUs in operation.

2. Description of Related Art

When GPUs are installed in servers of a data center to do complex computation operations, an increase of the computation operations of the servers due to an increase in graphics processing, the GPU may become overloaded resulting in a slower response or graphics output. Therefore, there is room for improvement in the art.

### BRIEF DESCRIPTION OF THE DRAWINGS

FIG. 1 is a block diagram of one embodiment of a GPU expansion card comprising a GPU expansion unit.

FIG. 2 is a block diagram of one embodiment of a server in which a plurality of GPUs are installed, where each GPU includes the GPU expansion card shown in FIG. 1.

FIG. 3 is a block diagram of one embodiment of function modules of a GPU expansion unit in the GPU expansion card of FIG. 1.

FIG. 4 illustrates a flowchart of one embodiment of a method of expanding GPUs in the server of FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

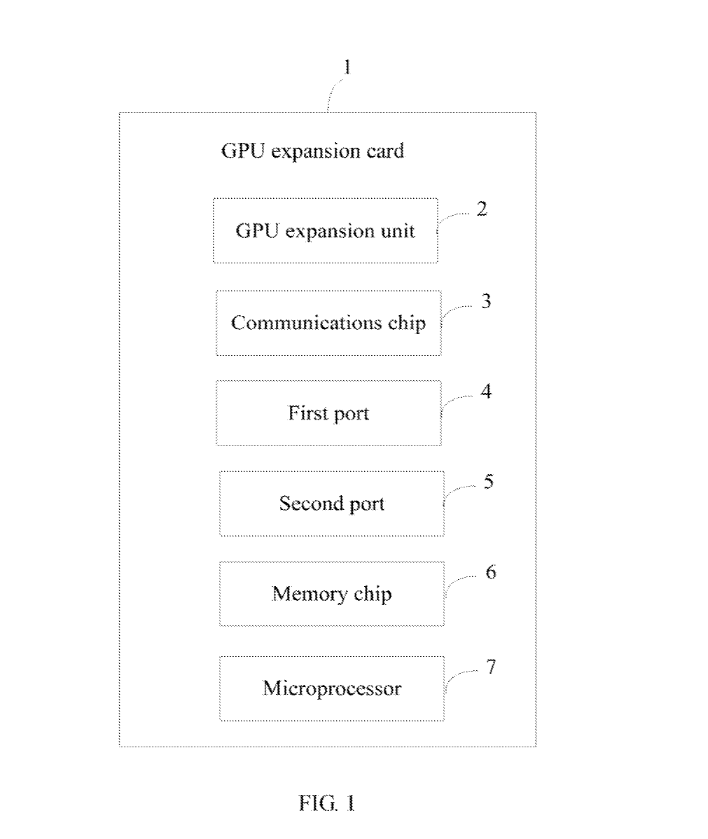

FIG. 1 is a block diagram of one embodiment of a graphics processing unit (GPU) expansion card 1. In one embodiment, the GPU expansion card 1 includes a GPU expansion unit 2, a communications chip 3, and two ports, namely a first port 4 and a second port 5. The communications chip 3 is responsible for intercommunications between GPUs which are installed on the expansion card 1. The two ports are used to connect one GPU with another GPU, or connect the GPU to a mother board. The GPU expansion card 1 may further include components such as a memory chip 6 and a microprocessor 7 as shown in FIG. 1, or may be configured in a number of other ways in other embodiments and may include other or different components from those shown in FIG. 1.

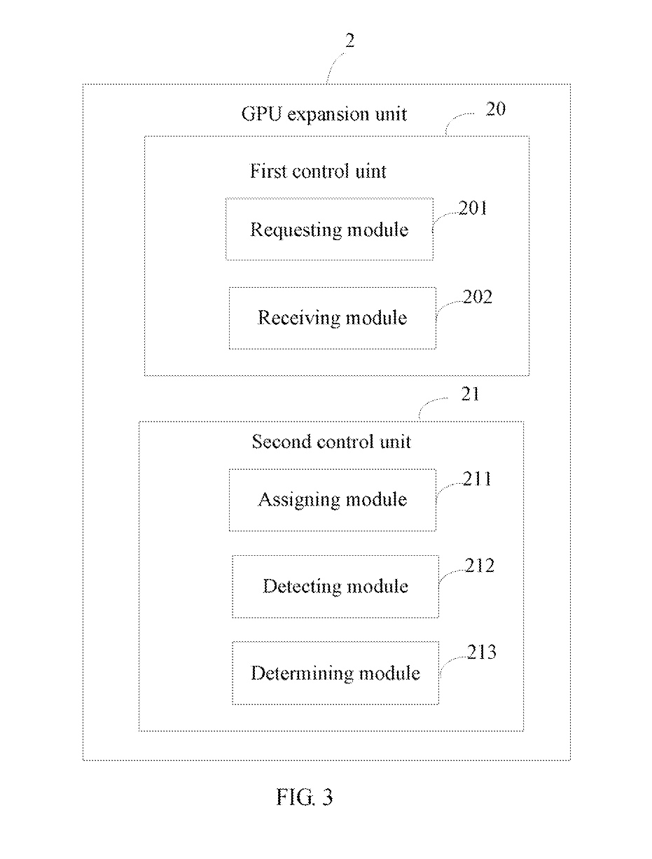

The unit 2 includes a number of function modules (depicted in FIG. 3). The function modules may include computerized codes in the form of one or more programs, which are stored in the memory chip 6. The microprocessor 7 executes the computerized codes of the function modules.

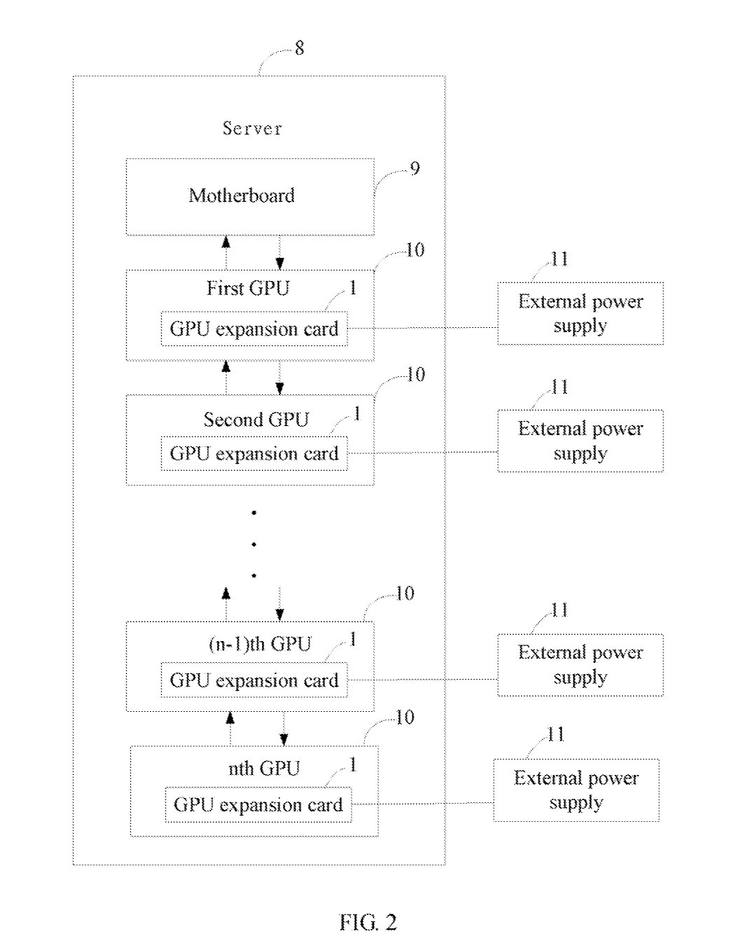

FIG. 2 is a block diagram of one embodiment of a server 8 that includes a plurality of GPUs 10. Each GPU 10 includes the GPU expansion card 1 shown in FIG. 1. For example, the server 8 includes a number (n−1) of GPUs 10, and the number (n−1) of GPUs 10 are connected with each other serially by the first port 4 and the second port 5, wherein n is an integer greater than one. A first GPU 10 is firstly connected, a second GPU 10 is secondly serially connected, and so on. The first GPU 10 is connected to a motherboard 9 of the server 8 via a port (e.g., the first port 4). The first GPU 10 may be connected to another GPU (e.g., a second GPU 10) via another port (e.g., the second port 5). In one embodiment, a GPU 10, that is an nth GPU 10, can be connected serially to an (n−1)th GPU 10 of the GPUs by a user of the server 8 to share computational operations loads of the number of (n−1) GPUs 10. Each GPU 10 is connected to an external power supply 11.

In one embodiment, a master GPU 10 is firstly connected and is connected to the motherboard 9 of the server 8 via a port (e.g., the first port 4). There is only one master GPU. For example, in FIG. 2, the first GPU 10 is the master GPU. Excepting the master GPU, all other GPUs 10, such as from the second GPU to the nth GPU, are regarded as secondary GPUs. For example, a port (e.g., the first port 4) of the master GPU 10 is connected to the motherboard 9 of the server 8, a port (e.g., the second port 5) of the first GPU 10 may be connected to a port (e.g., the first port 4) of the second GPU, a port (e.g., the second port 5) of the second GPU 10 may be connected to a port (e.g., the first port 4) of the third GPU, and so on. The master GPU assigns a slave address to each secondary GPU 10, and identifies and communicates with each of the secondary GPUs by the slave address. The master GPU communicates with the server 8 to transmit data, and balances operation loads of all the secondary GPUs according to operation workloads of the server 8.

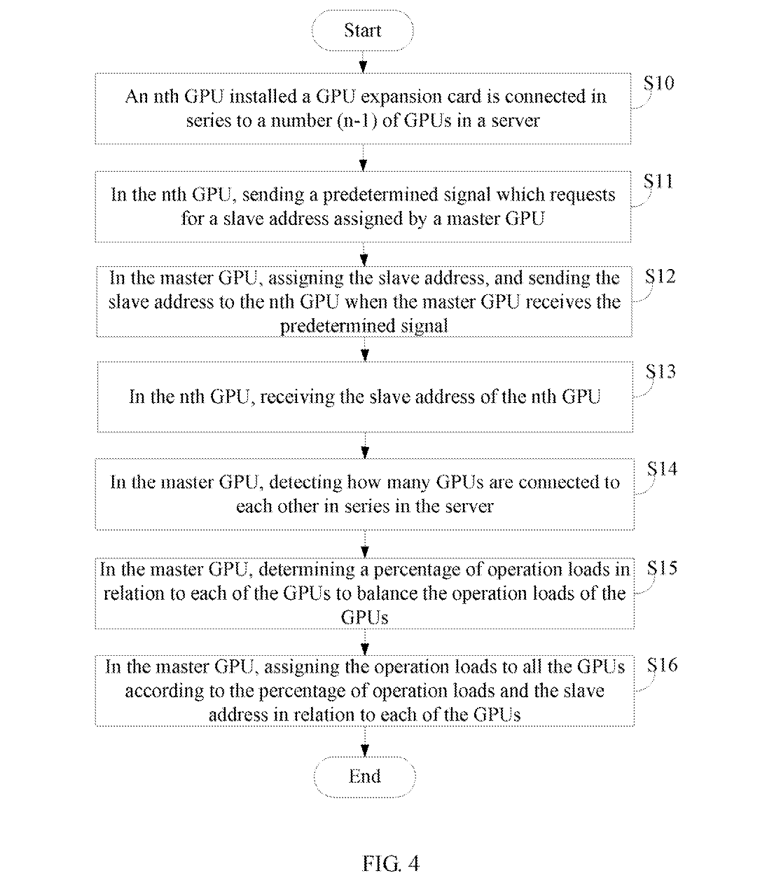

FIG. 3 is a block diagram of one embodiment of function modules of the unit 2. In one embodiment, the GPU expansion unit 2 may include a first control unit 20 and a second control unit 21. When the GPU expansion card 1 is installed in the secondary GPU, the first control unit 20 is activated. The first control unit 20 includes a requesting module 201, and a receiving module 202. When the GPU expansion card 1 is installed in the master GPU, the second control unit 21 is activated. The second control unit 21 includes an assigning module 211, a detecting module 212, and a determining module 213. A detailed description of the function modules 201-202 and 211-213 is given in reference to FIG. 4.

FIG. 4 illustrates a flowchart of one embodiment of a method of expanding GPU capabilities with the GPU expansion card in the electronic device of FIG. 1. Depending on the embodiment, additional steps may be added, others removed, and the ordering of the steps may be changed.

In step S10, an nth GPU 10 is connected in series to an (n−1)th GPU 10 installed in the server 8 via a port. In one embodiment, a number (n−1) of GPUs 10 are serially installed in the server 8, and the nth GPU 10 is serially connected to the (n−1)th GPU 10, wherein n is an integer greater than one. In one embodiment, a GPU (such as the first GPU 10 shown in FIG. 2), which is connected to the motherboard 9 of the server 8, is regarded as a master GPU, and all other GPUs 10 are regarded as secondary GPUs.

In step S11, the requesting module 201 in the nth GPU 10 sends a predetermined signal to the master GPU, to request a slave address for the nth GPU 10, via the communications chip 3. In one embodiment, the predetermined signal is passed in sequence between the GPUs 10 until reaching the master GPU. For example, when n is greater than three, the (n−1)th GPU 10 sends the predetermined signal to a (n−2)th GPU 10 that is connected to the (n−1)th GPU 10, and the (n−2)th GPU 10 passes the predetermined signal to the (n−3)th GPU 10 that is connected to the (n−2)th GPU 10, . . . , until the predetermined signal is passed to the master GPU.

In step S12, when the master GPU receives the predetermined signal, the assigning module 211 in the master GPU assigns a slave address and sends the slave address to a GPU 10 that is connected to the master GPU (e.g., the second GPU 10 as shown in FIG. 2). In one embodiment, the slave address is passed in sequence between the GPUs 10 until reaching the nth GPU 10. For example, the second GPU 10 sends the slave address to a third GPU 10 that is connected to the second GPU 10, . . . , until the slave address is passed to the nth GPU 10.

In step S13, when the slave address is passed to the nth GPU, the receiving module 202 in the nth GPU 10 receives the slave address.

In step S14, the detecting module 212 in the master GPU detects how many GPUs are connected with each other serially.

In step S15, according to the number of the GPUs which are connected serially with each other, the determining module 213 in the master GPU determines a percentage of operation loads in relation to each of the GPUs 10, to balance the operation loads of the GPUs 10.

For example, if the number of the GPUs is four, the percentage of operation loads in relation to each GPU 10 is, or should be, 25%. That is, each GPU 10 does 25% of the operations workload of the server 8. When the operation loads of one GPU 10 is more than the other GPUs 10, the GPU 10 can request the master GPU to balance the operation loads, until the operation loads of each GPU 10 is same.

In step S16, the assigning module 211 in the master GPU assigns the operation loads of the server 8 between all the GPUs 10 according to the percentage of operation loads and the slave address of each GPU 10.

It should be emphasized that the above-described embodiments of the present disclosure, including any particular embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A graphics processing unit (GPU) expansion card, comprising:
a communications chip;
two ports;
a microprocessor; and
a memory chip storing one or more programs which is executed by the microprocessor, causing the microprocessor to:
activate a first control unit of an nth GPU, which is connected to an (n−1)th GPU of a server, to send a predetermined signal to a master GPU which is connected to a motherboard of the server, to request for assigning a slave address to the nth GPU, wherein: n is an integer more than one, and the number n of GPUs are connected serially with each other in the server, the master GPU is a first GPU which is firstly connected; and
activate a second control unit of the master GPU to assign the slave address and send the slave address to the nth GPU, wherein the second control unit of the master GPU detects how many GPUs are connected with each other serially in the server, determines a percentage of operation loads of each of the GPUs to balance the operation loads of the GPUs according to the number of the GPUs, and assigns the operation loads between all the GPUs according to the percentage of operation loads and the slave address of each of the GPUs.

2. The GPU expansion card according to claim 1, wherein each GPU expansion card connects with an external power supply.

3. The GPU expansion card according to claim 1, wherein the predetermined signal is passed in sequence between the GPUs until reaching the master GPU.

4. The GPU expansion card according to claim 1, wherein the slave address is passed in sequence between the GPUs until reaching the nth GPU.

5. A computerized method being executed by at least one microprocessor of a graphics processing unit (GPU) expansion card, the method comprising:
activating a first control unit of an nth GPU, which is connected to an (n−1)th GPU of a server, to send a predetermined signal to a master GPU which is connected to a motherboard of the server, to request for assigning a slave address to the nth GPU, wherein: n is an integer more than one, and the number n of GPUs are connected serially with each other in the server, the master GPU is a first GPU which is firstly connected; and
activating a second control unit of the master GPU to assign the slave address and send the slave address to the nth GPU, wherein the second control unit of the master GPU detects how many GPUs are connected with each other serially in the server, determines a percentage of operation loads of each of the GPUs to balance the operation loads of the GPUs according to the number of the GPUs, and assigns the operation loads between all the GPUs according to the percentage of operation loads and the slave address of each of the GPUs.

6. The method according to claim 5, wherein each GPU expansion card connects with an external power supply.

7. The method according to claim 5, wherein the predetermined signal is passed in sequence between the GPUs until reaching the master GPU.

8. The method according to claim 5, wherein the slave address is passed in sequence between the GPUs until reaching the nth GPU.

9. A non-transitory storage medium having stored thereon instructions that, when executed by a microprocessor of a GPU expansion card, causes the microprocessor to perform graphics processing unit (GPU) expansion method in the expansion card, wherein the method comprises:
activating a first control unit of an nth GPU, which is connected to an (n−1)th GPU of a server, to send a predetermined signal to a master GPU which is connected to a motherboard of the server, to request for assigning a slave address to the nth GPU, wherein: n is an integer more than one, and the number n of GPUs are connected serially with each other in the server, the master GPU is a first GPU which is firstly connected; and
activating a second control unit of the master GPU to assign the slave address and send the slave address to the nth GPU, wherein the second control unit of the master GPU detects how many GPUs are connected with each other serially in the server, determines a percentage of operation loads of each of the GPUs to balance the operation loads of the GPUs according to the number of the GPUs, and assigns the operation loads between all the GPUs according to the percentage of operation loads and the slave address of each of the GPUs.

10. The non-transitory storage medium according to claim 9, wherein each GPU expansion card connects with an external power supply.

11. The non-transitory storage medium according to claim 9, wherein the predetermined signal is passed in sequence between the GPUs until reaching the master GPU.

12. The non-transitory storage medium according to claim 9, wherein the slave address is passed in sequence between the GPUs until reaching the nth GPU.
